(19) United States
(12) Patent Application Publication
(10) Pub. No.: US 2014/0267874 A1
(43) Pub. Date: Sep. 18, 2014

(54) INDICATING THE OPERATIONAL STATUS OF A CAMERA

(71) Applicants: Joshua J. Ratcliff, San Jose, CA (US); Douglas C. Mendez, Santa Clara, CA (US)

(72) Inventors: Joshua J. Ratcliff, San Jose, CA (US); Douglas C. Mendez, Santa Clara, CA (US)

(21) Appl. No.: 13/834,017

(22) Filed: Mar. 15, 2013

(51) Int. Cl. H04N 5/232

(52) U.S. Cl. CPC H04N 5/23245
USPC 348/335

(57) ABSTRACT

An electronic device, method, at least one machine readable medium, and apparatus for indicating the operational status of a camera are provided herein. The electronic device includes a camera function, a lens, and an element associated with the lens. The element includes a second state wherein the element substantially optically occludes the lens from being visible to an observer of the electronic device when the camera function is not activated. The element also includes a first state wherein the element is substantially optically transparent and does not occlude the lens from being visible to an observer of the electronic device when the camera function is activated.

### TECHNICAL FIELD

The present techniques relate generally to cameras and devices that include a camera. More particularly, the present techniques relate to a method and apparatus to indicate the operational status of a camera.

### BACKGROUND ART

Cameras and devices that include a camera function have become ubiquitous. Many different types of electronic devices now include integrated cameras, such as, for example, mobile/cellular telephones, laptop and tablet computers, and televisions. Stand-alone cameras, including wireless security cameras, are also increasingly being utilized to monitor private residences as well as public spaces. Such stand-alone cameras and devices with integral cameras are now present virtually every place we go. For many, this pervasive presence of cameras in virtually all public and private places raises privacy concerns, especially considering that it can be difficult if not impossible to tell when a camera, whether integrated or stand-alone, is operating, i.e., actively capturing still and/or video images.

Some cameras and/or devices with integral cameras have attempted to address the above-noted privacy concerns by providing a status indicator that indicates that the camera/device is actively capturing images. Although some cameras/devices may include such a status indicator, such as emitting a shutter sound or illuminating a light-emitting diode upon image capture or camera activation, the status indicators may often be deactivated by a user via the camera/device menu. Thus, there is not currently a good way to mitigate the above-noted privacy concerns.

### BRIEF DESCRIPTION OF THE DRAWINGS

FIG. 1 is a block diagram of an electronic device having an integral camera, in accordance with embodiments;

FIG. 2 is a detail view of the electronic device of FIG. 1;

FIGS. 3A and 3B are perspective views of a cellular phone, in accordance with embodiments;

FIGS. 4A and 4B are perspective views of a wearable camera, in accordance with embodiments;

FIGS. 5A and 5B are perspective views of a laptop computer, in accordance with embodiments;

FIG. 6 is a process flow diagram of a method of indicating the operational status of a camera, in accordance with embodiments; and

FIG. 7 is a block diagram illustrating a tangible, non-transitory machine readable medium that stores instructions for indicating the operational status of a camera, in accordance with embodiments.

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an electronic device 100 having an integral camera 102, in accordance with embodiments. The electronic device 100 may be, for example, a laptop computer, desktop computer, tablet computer, other portable computing device, mobile phone, television, wearable video camera, other image capture device, or the like. The camera 102 may include a lens 104. The electronic device 100 may further include one or more user interface devices 110 and 112, such as, for example, a display, keyboard, touch pad, and the like, by which the user controls and operates the electronic device 100 and the camera 102. The electronic device 100 may further include a power source 120, such as, for example, a battery.

FIG. 2 is a detail view of the electronic device 100 of FIG. 1. As shown in FIG. 2, the electronic device 100 may further include element 130 associated with the lens 104 of the camera 102. More particularly, at least a portion of the element 130 may be disposed over and entirely cover the lens 104. In various embodiments, the element 130 may be disposed over but spaced apart from the lens 104, in which embodiments the element 130 may also be disposed over and/or upon at least a portion of the surface 132 of the electronic device 100 with which the lens 104 is associated. For example, in such embodiments, the element 130 may be a sleeve or case that covers the lens 104 and at least a portion of the surface 132 of the electronic device 100. In other embodiments, the element 130 may be disposed upon and overlie the lens 104. In still other embodiments, the element 130 may be integral and unitary with at least a portion of the surface 132

Further, as shown in FIG. 1, the element 130 may be electrically connected to a power source 120. In various embodiments, the element 130 may be a layer of liquid-crystal film that is electrically modulated by the electronic device 100 between a first condition or state wherein the element 130 is substantially transparent and a second condition or state wherein the element 130 is substantially opaque. In other embodiments, the element 130 may be a layer of electrochromic film or glass that is also electrically modulated by the electronic device 100 between a first condition or state wherein the element 130 is substantially optically transparent and a second condition or state wherein the element 130 is substantially optically opaque.

In the first condition or state, wherein the element 130 is substantially transparent, the lens 104 is clearly visible through the element 130 to an observer of the electronic device 100. The element 130 may be placed in or caused to enter the first condition or state when, for example, the camera 102 is activated and/or when the electronic device 100 is placed in the camera mode of operation or is otherwise enabled to or in the process of capturing still or video images. When the camera 102 is activated and/or when the electronic device 100 is placed in the camera mode of operation, and when the element 130 is in the first condition or state, the camera 102 is operable to capture still or video images since the element 130 is optically substantially transparent.

Conversely, in the second condition or state, wherein the element 130 is substantially optically opaque, the lens 104 is not visible through the element 130 to an observer of the electronic device 100. The element 130 may be placed in or caused to enter the second condition or state when, for example, the camera 102 is not activated and/or when the electronic device 100 is not in the camera mode of operation or is otherwise not enabled to capture still or video images. When the element 130 is in the second condition or state, the camera 102 is not operable to capture still or video images since the lens 104 is occluded by the element 130.

The electronic device 100 may also include a memory 140, such as, for example, a tangible, non-transitory machine readable medium. In some embodiments, the memory 140 may be configured as non-volatile read only memory, random access memory, hard disk drive, flash memory, synchronous dynamic random access memory, or other suitable non-volatile media. The memory 140 may store the operating system for the electronic device 100 and may also store instructions 150 that, when executed, direct the electronic device 100 to perform the techniques described herein.

The electronic device 100 may further include a central processing unit (CPU) 160, such as a single or multi-core microprocessor, that may be electrically connected with the power supply 120, the user interface devices 110 and 112, the element 130, and the memory 140. The CPU 160 is configured to enable the operation and functionality of the electronic device 100, including activating and deactivating the camera 102, placing the electronic device 100 into and out of the camera mode of operation, and causing the element 130 to enter the first and second conditions or states. More particularly, the CPU 160 is configured to enable the operation and functionality of the electronic device 100, including the camera function, as well as control the operating condition/state of the element 130 by executing the operating system of the electronic device 100, which may include instructions 150 stored in the memory 140 and elsewhere.

In some embodiments, the camera 102 is operably associated with an image sensor (not shown) of the electronic device 100. The image sensor may be connected directly to the CPU 160 via a private bus or sensor interface (not shown). Further, in various embodiments, the image sensor is communicably coupled to a sensor hub (not shown) via the sensor interface. The sensor hub may be configured to collect sensor data from the image sensor. In some embodiments, one or more microcontrollers within the electronic device 100 may provide the sensor data collected via the image sensor to the sensor hub.

FIGS. 3A and 3B are perspective views of a cellular phone 300. In various embodiments, the techniques described herein may be implemented in conjunction with the cellular phone 300 of FIG. 3. The cellular phone 300 includes a front surface 302 and a back surface 304. The front surface 302 includes a display 306, such as, for example, a liquid crystal or organic light emitting diode touch-screen display, which may present a user interface for the operation and control of the cellular phone 300. The back surface 304 includes a region 310 with which a lens 314 is associated or within which the lens 314 is disposed. A flash device 320 is also disposed within or associated with the region 310. The lens 314 is operably associated with an image sensor (not shown) of the cellular phone 300, which includes a camera feature that utilizes the image sensor, the lens 314 and, optionally, the flash device 320.

In various embodiments, the region 310 of the back surface 304 is covered by an element 330. The element 330 may be disposed over but spaced apart from the region 310, thereby covering the lens 314, and may extend to also cover the flash device 320. The element 330 may also cover at least a portion of the back surface 304 of the cellular phone 300. In other embodiments, the entire back surface 304 is constructed at least in part of, or is covered by, the element 330. The element 330 may be electrically connected to a power source of the cellular phone 300, such as a battery. The element 330 may be a layer of electrochromic film or glass, a liquid-crystal film, or a film or layer of another electrochomic or other suitable material.

The cellular phone 300 may switch the element 330 between a first condition or state and a second condition or state via electrical modulation, for example. In the first condition or state, the element 330 is substantially optically transparent. In contrast, in the second condition or state, the element 330 is substantially optically opaque. The cellular phone 300 may switch the element 330 between the first condition or state and the second condition or state based, at least in part, on whether or not the camera mode of operation of the cellular phone 300 is activated.

More particularly, referring specifically to FIG. 3A, the cellular phone 300 is illustrated in the camera mode of operation wherein the element 330 is placed in the first condition or state and is thus substantially optically transparent, thereby rendering the lens 314 and the flash device 320 clearly visible to an observer of the cellular phone 300. When the element 330 is in the first condition or state and is thus substantially optically transparent, light and images may pass through to the lens 314, and light emitted from the flash device 320 may pass through to the external environment, thereby enabling the camera of the cellular phone 300 to capture still or video images.

Conversely, referring particularly to FIG. 3B, the cellular phone 300 is illustrated in a mode of operation other than the camera mode of operation wherein the element 330 is placed in the second condition or state and is thus substantially optically opaque, thereby rendering the lens 314 and the flash device 320 not visible to, and occluded from the view of, an observer of the cellular phone 300. When the element 330 is in the second condition or state and is thus substantially optically opaque, light and images may be precluded from passing through to lens 314, and the camera of the cellular phone 300 may be precluded from capturing still or video images.

FIGS. 4A and 4B are perspective views of a wearable camera 400, in accordance with embodiments. In various embodiments, the techniques described herein may be implemented in conjunction with the wearable camera 400 of FIG. 4. The wearable camera 400 may be configured as a still frame or video camera. The wearable camera 400 has a surface 404 in association with which a lens 414 of the camera 400 is disposed. An element 430 may be disposed upon and may cover the lens 414, and may be connected to a power source of the wearable camera 400, such as a battery. In other embodiments, the element 430 may be spaced part from, disposed over and cover lens 414, and may extend beyond the lens 414 to cover at least a portion of the surface 404. In still other embodiments, the surface 404 is constructed at least in part of, or is covered by, the element 430. The element 430 may be a layer of electrochromic film or glass, a liquid-crystal film, or film or layer of another electrochomic or other suitable material. The element 430 may be electrically modulated by the wearable camera 400 between a first condition or state wherein the element 430 is substantially optically transparent and a second condition or state wherein element the 430 is substantially optically opaque. The wearable camera 400 may electrically modulate the element 430 between the first condition or state and the second condition or state based, at least in part, on whether or not the wearable camera 400 is activated, i.e., operable to capture still or video images.

More particularly, referring specifically to FIG. 4A, the wearable camera 400 is illustrated in a mode or condition of being operable to capture images, and with the element 430 placed in the first condition or state wherein it is substantially optically transparent, thereby rendering the lens 414 clearly visible to an observer of the wearable camera 400. When the element 430 is in the first condition or state and is thus substantially optically transparent, the element 430 allows light and images to pass through to the lens 414 and thus permits the capture of images by the wearable camera 400.

Conversely, referring now particularly to FIG. 4B, the wearable camera 400 is illustrated in a mode or condition of not being operable to capture images, and with the element 430 placed in the second condition or state wherein it is substantially optically opaque, thereby rendering the lens 414 not visible to and occluded from an observer of the wearable camera 400. When the element 430 is in the second condition or state and is thus substantially optically opaque, the element 430 occludes light and images from passing through to the lens 414 and thus precludes the capture of images by the wearable camera 400. In various embodiments, the color of the element 430 may, when in the first condition or state of being optically substantially opaque, be configured to match the color of the surface 404 and/or of the wearable camera 400 to enhance the aesthetics of the wearable camera 400.

FIGS. 5A and 5B are perspective views of a laptop computer 500, in accordance with embodiments. In various embodiments, the techniques described herein may be implemented in conjunction with the laptop computer 500 of FIG. 5. The laptop computer 500 includes a surface 504 in association with which a lens 514 is disposed. The lens 514 may be one component of a web cam, other camera system or camera function of the laptop computer 500. An element 530 may be disposed upon and may cover the lens 514, and may be connected to a power source of the laptop computer 500, such as a battery. In other embodiments, the element 530 may be spaced part from, disposed over and cover the lens 514, and may extend beyond the lens 514 to cover at least a portion of the surface 504. In still other embodiments, the surface 504 is constructed at least in part of, or is covered by, the element 530.

The element 530 may be a layer of electrochromic film or glass, a liquid-crystal film, or a layer or film of another electrochomic or other suitable material that is electrically modulated by the laptop computer 500 between a first condition or state and a second condition or state. In the first condition or state, the element 530 is substantially optically transparent. In contrast, in the second condition or state, the element 530 is substantially optically opaque. The laptop computer 500 may electrically module the element 530 between the first condition or state and the second condition or state based, at least in part, on whether or not the laptop computer 500 is in the camera mode of operation and/or whether the web cam or camera of the laptop computer 500 is activated, i.e., operable to capture still or video images.

More particularly, referring specifically to FIG. 5A, the laptop 500 computer is illustrated with its webcam or camera in a mode or condition of being operable to capture images, and with the element 530 placed in the first condition or state wherein it is substantially optically transparent, thereby rendering the lens 514 clearly visible to an observer of the laptop computer 500. When the element 530 is in the first condition or state and is thus substantially optically transparent, light and images may pass through to the lens 514, permitting the capture of images by the camera or camera function of the laptop computer 500.

Conversely, referring now particularly to FIG. 5B, the laptop computer 500 is illustrated with its webcam or camera in a mode or condition wherein it is not operable to capture images, and with the element 530 in the second condition or state wherein it is substantially optically opaque, thereby rendering the lens 514 not visible to, and occluded from the view of, an observer of the laptop computer 500. When the element 530 is in the second condition or state and is thus substantially optically opaque, light and images are precluded from passing through to the lens 514, thereby precluding the capture of images by the camera or camera function of the laptop computer 500. In various embodiments, the color of the element 530 may, when in the first condition or state of being optically substantially opaque, be configured to match the color of the surface 504 and/or of the laptop computer 500 to thereby enhance the aesthetics of the laptop computer 500.

FIG. 6 is a process flow diagram of a method 600 of indicating the operational status of a camera, in accordance with embodiments. In various embodiments, the method 600 provides an indication of the operational status of a camera that is integral with an electronic device, such as, for example, a cellular phone, tablet or laptop computer, a wearable camera, other still or video camera, or other image-capturing device. In some embodiments, the method 600 may be executed by such an electronic device, as will be more particularly described hereinafter. Further, the method 600 may be embodied by the operating system or firmware of such an electronic device. The method 600 includes determining whether the camera mode of a device is operational 610, placing an element in a first condition or state if the camera mode is operational 620, and placing the element in a second condition or state if the camera mode is not operational 630.

At block 610, the operational mode of the electronic device is monitored to determine whether the camera mode of the electronic device is being or has been activated and/or is operational. More particularly, in various embodiments, the operational mode of the electronic device is substantially continuously monitored to detect activation and deactivation of the camera and/or activation and deactivation of the camera mode of operation of the electronic device to thereby determine whether the electronic device is or is about to be operable to capture still or video images via the camera.

Upon detection at block 610 that the camera is or is about to be activated and/or the camera mode of operation is or is about to be activated, i.e., when the device camera is or is about to be operable to capture still or video images, block 620 causes an element of the electronic device to enter a first condition or state wherein the lens associated with the camera is visible to an observer of the electronic device. In addition, a flash device and/or an optical sensor, such as an image sensor, proximity sensor, infrared emitter, or the like, associated with the camera may be visible to the observer of the electronic device when the element is in the first condition or state. Specifically, the element of the electronic device may be caused to enter the first condition or state wherein the element is substantially optically transparent. Block 610 continues to monitor the operational status of the camera and/or the operational mode of the electronic device.

Upon detection at block 610 that the camera or camera mode of operation is or is about to be deactivated, i.e., when the device camera is or is about to be not operable to capture still or video images, block 630 causes an element of the electronic device to enter a second condition or state wherein the lens associated with the camera is not visible to an observer of the device. In addition, the flash device and/or optical sensor associated with the camera may not be visible to the observer of the electronic device when the element is in the second condition or state. Specifically, the element of the electronic device may be caused to enter the second condition or state wherein the element is substantially optically opaque. Block 610 continues to monitor the operational status of the camera and/or the operational mode of the electronic device.

The process flow diagram of FIG. 6 is not intended to indicate that the blocks of the method 600 are to be executed in any particular order, or that all of the blocks shown in FIG. 6 are to be included in every case. Further, the method 600 may include any number of additional blocks not shown in FIG. 6, depending on the details of the specific implementation.

FIG. 7 is a block diagram showing a tangible, non-transitory machine readable medium 700 storing code for indicating the operational status of a camera, in accordance with embodiments. The tangible, non-transitory machine readable medium 700 may be accessed by a processor 702 over a signal bus 704 of an electronic device, such as the electronic device 100 discussed with respect to FIG. 1. Furthermore, the tangible, non-transitory machine readable medium 700 may include code configured to direct the processor 702 to perform the methods described herein, and particularly the method 600. The tangible, non-transitory machine readable medium 700 may store various software components or modules, including components or modules corresponding to the processes of the method 600.

For example, the tangible, non-transitory machine readable medium 700 may include a module 710 that substantially continuously monitors the operational mode of an electronic device to detect activation and deactivation of the camera and/or activation and deactivation of the camera mode of operation of the electronic device to thereby determine whether the device is or is about to be operable to capture still or video images via the camera. Module 710 continually monitors the operational status of the camera and/or the operational mode of the electronic device.

Upon detection by module 710 that the camera mode or camera of the device is or is about to become operational, module 720 may cause an element of the electronic device to enter a first condition or state that renders the lens of the camera to be visible to an observer of the electronic device. In various embodiments, module 720 may place the element of the electronic device in the first condition or state upon detection by module 710 that the camera mode or camera of the electronic device is or is about to become operational. Module 710 continues to monitor the operational status of the camera and/or the operational mode of the electronic device.

Upon detection by module 710 that the camera mode or camera of the device is or is about to become nonoperational, module 730 may cause an element of the electronic device to enter a second condition or state that renders the lens of the camera or device to be not visible to an observer of the device. In various embodiments, module 730 may place the element of the electronic device in the second condition or state upon detection by module 710 that the camera mode or camera of the device is or is about to become nonoperational. Module 710 continues to monitor the operational status of the camera and/or the operational mode of the electronic device.

The block diagram of FIG. 7 is not intended to indicate that the tangible, non-transitory machine readable medium 700 is to include all of the components shown therein. Further, the tangible, non-transitory machine readable medium 700 may include any number of additional components not shown in FIG. 7, depending on the details of the specific implementation.

### EXAMPLE 1

An electronic device is provided herein. The electronic device includes a camera function, a lens, and an element associated with the lens. The element includes a second state wherein the element substantially optically occludes the lens from being visible to an observer of the electronic device when the camera function is not activated. The element also includes a first state wherein the element is substantially optically transparent and does not occlude the lens from being visible to an observer of the electronic device when the camera function is activated.

The element may be an electrochromic element. Alternatively, the element may be a liquid crystal element. The element may be spaced apart from and overlie the lens. The element may be disposed on the lens. The element may be integral with the lens. The element may overlie at least a portion of a surface of the electronic device. Further, the element may be integral with a surface of the electronic device.

The electronic device may also include a flash device. The element, while in the second state, may substantially optically occlude the flash device from being visible to the observer of the electronic device. The element, while in the first state, may not occlude the flash device from being visible to the observer of the electronic device. Further, the electronic device may include an optical sensor. The element, while in the second state, may substantially optically occlude the optical sensor from being visible to the observer of the electronic device. The element, while in the first state, may not occlude the optical sensor from being visible to the observer of the electronic device.

The electronic device may also include a central processing unit configured to execute stored instructions and at least one memory device storing instructions readable by the central processing unit. The instructions, when executed by the central processing unit, are configured to detect whether the camera function is activated or not activated, cause the element to enter the first state when the camera function is activated, and cause the element to enter the second state when the camera function is not activated.

In some embodiments, the electronic device is a mobile phone. In other embodiments, the electronic device is a tablet computer.

### EXAMPLE 2

A method for indicating the operational status of a camera is provided herein. The method includes monitoring the operational status of a camera, optically occluding to an observer of the camera a lens of the camera when the camera is not operational, and optically revealing to the observer of the camera the lens when the camera is operational.

Optically occluding the lens may include causing an electrochromic element associated with the lens to enter an optically opaque state, and optically revealing the lens may include causing the electrochromic element to enter an optically transparent state. Alternatively, optically occluding the lens may include causing a liquid crystal element associated with the lens to enter an optically opaque state, and optically revealing the lens may include causing the liquid crystal element to enter an optically transparent state.

The method may also include optically occluding to the observer of the camera a flash device of the camera when the camera is not operational, and optically revealing to the observer of the camera the flash device when the camera is operational. Optically occluding the flash device may include causing an electrochromic element associated with the flash device of the camera to enter an optically opaque state, and optically revealing the flash device may include causing the electrochromic element to enter an optically transparent state. Alternatively, optically occluding the flash device may include causing a liquid crystal element associated with the flash device of the camera to enter an optically opaque state, and optically revealing the flash device may include causing the liquid crystal element to enter an optically transparent state. Furthermore, the method may include optically occluding to the observer of the camera an optical sensor associated with the camera when the camera is not operational, and optically revealing to the observer of the camera the optical sensor when the camera is operational.

### EXAMPLE 3

At least one machine readable medium is provided herein. The readable medium includes instructions stored therein that, in response to being executed on an electronic device, cause the electronic device to monitor an operational status of a camera of the electronic device, optically occlude to an observer of the electronic device a lens of the camera when the camera is not operational, and optically reveal to the observer of the electronic device the lens of the camera when the camera is operational.

The instructions may cause the electronic device to monitor the operational status of the camera by detecting activation and deactivation of at least one of the camera and a camera mode of operation of the electronic device. In addition, the instructions may cause the electronic device to optically occlude and optically reveal the lens of the camera, respectively, by causing an electrochromic element to enter an optically opaque state and causing the electrochromic element to enter an optically transparent state. Alternatively, the instructions may cause the electronic device to optically occlude and optically reveal the lens of the camera, respectively, by causing an liquid crystal element to enter an optically opaque state and causing the liquid crystal element to enter an optically transparent state.

### EXAMPLE 4

An apparatus is provided herein. The apparatus includes an electronic device, including a housing, a camera, and a lens operably coupled with the camera and disposed in association with a region of the housing. The apparatus also includes an element overlying the lens of the electronic device. The element includes an optically opaque state wherein the element substantially optically occludes the lens from being visible to an observer of the apparatus when the camera is not operational and an optically transparent state wherein the element does not occlude the lens from being visible to the observer of the electronic device when the camera is operational.

The element may be an electrochromic element. Alternatively, the element may be a liquid crystal element. The region of the housing may be constructed at least in part of the element and may overly the lens.

The apparatus may also include a central processing unit (CPU), a memory accessible by the CPU, and instructions stored in the memory that, when executed by the CPU, detect activation and deactivation of at least one of the camera and a camera mode of operation of the apparatus. Further, the instructions, when executed by the CPU, may cause the element to enter the optically opaque state when the CPU detects at least one of the camera and the camera mode of operation is deactivated, and may cause the element to enter the optically transparent state when the CPU detects activation of at least one of the camera and the camera mode of operation.

In some embodiments, the electronic device is a mobile phone. In other embodiments, the electronic device is a tablet computer.

It is to be understood that specifics in the aforementioned examples may be used anywhere in one or more embodiments. For instance, all optional features of exemplary devices described above may also be implemented with respect to any of the other exemplary devices and/or the method described herein. Furthermore, although flow diagrams and/or state diagrams may have been used herein to describe embodiments, the present techniques are not limited to those diagrams or to their corresponding descriptions. For example, the illustrated flow need not move through each box or state or in exactly the same order as depicted and described.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. An electronic device, comprising:
a camera function;
a lens; and
an element associated with the lens, the element comprising:
a second state wherein the element substantially optically occludes the lens from being visible to an observer of the electronic device when the camera function is not activated; and
a first state wherein the element is substantially optically transparent and does not occlude the lens from being visible to an observer of the electronic device when the camera function is activated.

2. The electronic device of claim 1, wherein the element is an electrochromic element.

3. The electronic device of claim 1, wherein the element comprises a liquid crystal element.

4. The electronic device of claim 1, wherein the element is spaced apart from and overlies the lens.

5. The electronic device of claim 1, wherein the element is disposed on the lens.

6. The electronic device of claim 1, wherein the element is integral with the lens.

7. The electronic device of claim 1, wherein the element overlies at least a portion of a surface of the electronic device.

8. The electronic device of claim 1, wherein the element is integral with a surface of the electronic device.

9. The electronic device of claim 1, further comprising a flash device, wherein the element, while in the second state, substantially optically occludes the flash device from being visible to the observer of the electronic device, and wherein the element, while in the first state, does not occlude the flash device from being visible to the observer of the electronic device.

10. The electronic device of claim 1, further comprising an optical sensor, wherein the element, while in the second state, substantially optically occludes the optical sensor from being visible to the observer of the electronic device, and wherein the element, while in the first state, does not occlude the optical sensor from being visible to the observer of the electronic device.

11. The electronic device of claim 1, further comprising:
a central processing unit configured to execute stored instructions; and
at least one memory device storing instructions readable by the central processing unit that, when executed by the central processing unit, are configured to:
detect whether the camera function is activated or not activated;
cause the element to enter the first state when the camera function is activated; and
cause the element to enter the second state when the camera function is not activated.

12. The electronic device of claim 1, wherein the electronic device comprises a mobile phone.

13. The electronic device of claim 1, wherein the electronic device comprises a tablet computer.

14. A method of indicating the operational status of a camera, comprising:
monitoring the operational status of a camera;
optically occluding to an observer of the camera a lens of the camera when the camera is not operational; and
optically revealing to the observer of the camera the lens when the camera is operational.

15. The method of claim 14, wherein optically occluding the lens comprises causing an electrochromic element associated with the lens to enter an optically opaque state, and wherein optically revealing the lens comprises causing the electrochromic element to enter an optically transparent state.

16. The method of claim 14, wherein optically occluding the lens comprises causing a liquid crystal element associated with the lens to enter an optically opaque state, and wherein optically revealing the lens comprises causing the liquid crystal element to enter an optically transparent state.

17. The method of claim 14, further comprising optically occluding to the observer of the camera a flash device of the camera when the camera is not operational, and optically revealing to the observer of the camera the flash device when the camera is operational.

18. The method of claim 17, wherein optically occluding the flash device comprises causing an electrochromic element associated with the flash device of the camera to enter an optically opaque state, and wherein optically revealing the flash device comprises causing the electrochromic element to enter an optically transparent state.

19. The method of claim 17, wherein optically occluding the flash device comprises causing a liquid crystal element associated with the flash device of the camera to enter an optically opaque state, and wherein optically revealing the flash device comprises causing the liquid crystal element to enter an optically transparent state.

20. The method of claim 14, further comprising optically occluding to the observer of the camera an optical sensor associated with the camera when the camera is not operational, and optically revealing to the observer of the camera the optical sensor when the camera is operational.

21. At least one machine readable medium having instructions stored therein that, in response to being executed on an electronic device, cause the electronic device to:
monitor an operational status of a camera of the electronic device;
optically occlude to an observer of the electronic device a lens of the camera when the camera is not operational; and
optically reveal to the observer of the electronic device the lens of the camera when the camera is operational.

22. The machine readable medium of claim 21, wherein the instructions cause the electronic device to monitor the operational status of the camera by detecting activation and deactivation of at least one of the camera and a camera mode of operation of the electronic device.

23. The machine readable medium of claim 21, wherein the instructions cause the electronic device to optically occlude and optically reveal the lens of the camera, respectively, by causing an electrochromic element to enter an optically opaque state and causing the electrochromic element to enter an optically transparent state.

24. The machine readable medium of claim 21, wherein the instructions cause the electronic device to optically occlude and optically reveal the lens of the camera, respectively, by causing an liquid crystal element to enter an optically opaque state and causing the liquid crystal element to enter an optically transparent state.

25. An apparatus, comprising:
an electronic device, comprising:
a housing;
a camera; and
a lens operably coupled with the camera and disposed in association with a region of the housing; and
an element overlying the lens of the electronic device, the element comprising:
an optically opaque state wherein the element substantially optically occludes the lens from being visible to an observer of the apparatus when the camera is not operational; and
an optically transparent state wherein the element does not occlude the lens from being visible to the observer of the electronic device when the camera is operational.

26. The apparatus of claim 25, wherein the element comprises an electrochromic element.

27. The apparatus of claim 25, wherein the element comprises a liquid crystal element.

28. The apparatus of claim 25, wherein the region of the housing is constructed at least in part of the element and overlies the lens.

29. The apparatus of claim 25, further comprising:
a central processing unit (CPU);
a memory accessible by the CPU; and
instructions stored in the memory that, when executed by the CPU, detect activation and deactivation of at least one of the camera and a camera mode of operation of the apparatus.

30. The apparatus of claim 29, wherein the instructions, when executed by the CPU, cause the element to enter the optically opaque state when the CPU detects at least one of the camera and the camera mode of operation is deactivated, and cause the element to enter the optically transparent state when the CPU detects activation of at least one of the camera and the camera mode of operation.

31. The apparatus of claim 25, wherein the electronic device comprises a mobile phone.

32. The apparatus of claim 25, wherein the electronic device comprises a tablet computer.
